(19) United States
(12) Patent Application Publication
(10) Pub. No.: US 2008/0207858 A1
(43) Pub. Date: Aug. 28, 2008

(54) CATALYST, ITS PREPARATION AND USE

(76) Inventors: Ruth Mary Kowaleski, Cypress, TX (US); David Morris HAMILTON, Sugar Land, TX (US)

Correspondence Address: Shell Oil Company, 910 Louisiana, Houston, TX, 77002, US

(21) Appl. No.: 12/015,331

(22) Filed: Jan. 16, 2008

Related U.S. Application Data
(60) Provisional application No. 60/885,520, filed on Jan. 18, 2007.

(51) Int. Cl. C08F 4/44; B01J 23/58; B01J 23/00

(52) U.S. Cl. 526/176; 502/330; 502/317

(57) ABSTRACT

A process for preparing a catalyst which process comprises preparing a mixture comprising iron oxide and at least one Column 1 metal or compound thereof, wherein the iron oxide is obtained by heating a mixture comprising an iron halide and at least 0.05 millimoles of a Column 6 metal per mole of iron; a catalyst made by the above described process; an iron oxide composition; a process for the dehydrogenation of an alkylaromatic compound which process comprises contacting the alkylaromatic compound with the catalyst; and a method of using an alkenylaromatic compound for making polymers or copolymers, in which the alkenylaromatic compound has been produced by the dehydrogenation process.

This application claims the benefit of U.S. Provisional Application No. 60/885,520, filed Jan. 18, 2007, which is hereby incorporated by reference.

### FIELD OF THE INVENTION

The present invention relates to a catalyst, a process for preparing the catalyst, an iron oxide composition, a process for the dehydrogenation of an alkylaromatic compound and a method of using an alkenylaromatic compound for making polymers or copolymers.

### BACKGROUND

Iron oxide based catalysts and the preparation of such catalysts are known in the art. Iron oxide based catalysts are customarily used in the dehydrogenation of an alkylaromatic compound to yield, among other compounds, a corresponding alkenylaromatic compound. In this field of catalytic dehydrogenation of alkylaromatic compounds to alkenylaromatic compounds there are ongoing efforts to develop improved catalysts that may be made at lower costs. One way of reducing the cost of iron oxide based dehydrogenation catalysts is to use lower cost raw materials. For example, the use of regenerator iron oxide produced by spray roasting hydrochloric acid waste liquid generated from steel pickling may result in substantial cost savings in raw material costs in comparison to the use of other sources of iron oxide.

One drawback of using lower cost raw materials is the presence or increased amount of impurities in such lower cost raw materials. For example, regenerator iron oxide produced by the spray roasting process may contain residual chloride. This residual chloride content has an adverse effect on catalyst performance. For example, residual chloride content can result in slower startup of a dehydrogenation process and poorer initial catalyst activity. To produce high performing catalysts from lower cost raw materials such as regenerator iron oxide, a method for removing some or all of the impurities that adversely affect catalyst performance is desirable.

One method of reducing the chloride content involves calcining of the regenerator iron oxide as described in U.S. Pat. No. 6,863,877 and U.S. Patent Application Publication 2004/0097768. However, this process causes a reduction in the surface area of the iron oxide.

EP 1027928-B1 discloses catalysts containing iron oxide produced by the spray roasting of an iron salt solution. The iron oxide produced by the spray roasting process has a residual chloride content in the range of from 800 to 1500 ppm chloride. The iron oxide is typically combined with at least one potassium compound and one or more catalyst promoters to produce a catalyst. The patent discloses that a portion of the potassium compound and/or a portion of the promoters can for example be added to the iron salt solution used for spray roasting. This patent does not disclose a solution to the problem of residual chloride content or the adverse effect such residual chloride content may have on dehydrogenation catalyst performance.

### SUMMARY OF THE INVENTION

The invention provides a process for preparing a catalyst which process comprises preparing a mixture comprising iron oxide and at least one Column 1 metal or compound thereof, wherein the iron oxide is obtained by heating a mixture comprising an iron halide and at least 0.05 millimoles of a Column 6 metal per mole of iron.

The invention further provides a catalyst comprising iron oxide and at least one Column 1 metal or compound thereof wherein the iron oxide is obtained by heating a mixture comprising an iron halide and at least 0.05 millimoles of a Column 6 metal per mole of iron.

The invention further provides a composition comprising iron oxide formed by heating an iron chloride in the presence of at least one Column 6 metal or compound thereof, and at least one Column 1 metal or compound thereof wherein the iron oxide has a chloride content of at most 500 ppmw and a BET surface area of at least 2.5 m²/g.

The invention further provides a process for the dehydrogenation of an alkylaromatic compound which process comprises contacting a feed comprising the alkylaromatic compound with a catalyst comprising iron oxide and at least one Column 1 metal or compound thereof wherein the iron oxide is obtained by heating a mixture comprising an iron halide and at least one Column 6 metal per mole of iron.

The invention further provides a method of using an alkenylaromatic compound for making polymers or copolymers, comprising polymerizing the alkenylaromatic compound to form a polymer or copolymer comprising monomer units derived from the alkenylaromatic compound, wherein the alkenylaromatic compound has been prepared in a process for the dehydrogenation of an alkylaromatic compound using a catalyst comprising iron oxide and at least one Column 1 metal or compound thereof wherein the iron oxide is obtained by heating a mixture comprising an iron halide and at least one Column 6 metal per mole of iron.

### BRIEF DESCRIPTION OF DRAWINGS

FIG. 1 depicts the calculated catalyst activity at 70% conversion (T70) in degrees Celsius for two catalysts tested in duplicate.

FIG. 2 depicts the actual conversion of ethylbenzene achieved during testing of two catalysts that were tested in duplicate.

### DETAILED DESCRIPTION OF THE INVENTION

The present invention provides a catalyst that satisfies the need for lower cost iron oxide based catalysts. The iron oxide is prepared by heating an iron halide in combination with a Column 6 metal. The use of Column 6 metals or compounds thereof in this process provides an iron oxide that has reduced levels of halide relative to the case where the Column 6 metal is not present. The catalyst produced using this iron oxide has a corresponding low level of halides, and catalyst performance is improved. The catalyst demonstrates a higher initial activity than other iron oxide based catalysts where the iron oxide is not formed in the presence of a Column 6 metal or compound thereof.

The surface area of the regenerator iron oxide of the present invention provides more active sites for incorporation of a Column 1 metal or compound thereof and/or additional catalyst components than other regenerator iron oxides that have been treated by heat-treating or calcining to reduce halide content.

The iron oxide based dehydrogenation catalyst of the present invention is formed by mixing an iron oxide based catalyst precursor, hereinafter referred to as doped regenerator iron oxide, with additional catalyst components and calcining the mixture. The doped regenerator iron oxide is formed by heating a mixture comprising iron halide and a Column 6 metal or compound thereof to form iron oxide. In a preferred embodiment, the doped regenerator iron oxide is formed by spray roasting a mixture of iron halide and a compound of molybdenum to produce iron oxide comprising molybdenum.

The iron halide component of the iron halide/Column 6 metal mixture is preferably waste pickle liquor solution as generated by a steel pickling process. Waste pickle liquor is an acidic solution, typically comprising hydrochloric acid, which contains iron chloride. Alternatively, the iron halide may be present in dry or powder form or in an aqueous or acidic solution. The iron halide is preferably a chloride, but may also be a bromide. The iron may be at least partly present in a cationic form. The iron may be present in one or more of its forms including divalent or trivalent. An iron halide comprising chloride may be at least partly present as iron(II) chloride (FeCl₂) and/or iron(III) chloride (FeCl₃).

The Column 6 metal component of the iron halide/Column 6 metal mixture is a metal in Column 6 of the Periodic Table that includes chromium, molybdenum, and tungsten. One or more of these metals or compounds thereof may be present. The Column 6 metal is preferably molybdenum. A Column 6 metal compound may include hydroxides, oxides, and/or salts of Column 6 metals. The salts of Column 6 metals may include chlorides, sulfates and/or carbonates of Column 6 metals. Further, the Column 6 metal compound may comprise an organoamine salt or an ammonium salt of an oxy acid derived from the Column 6 metal, for example ammonium dimolybdate or ammonium heptamolybdate. The Column 6 metal compound may comprise molybdenum trioxide.

The Column 6 metal or compound thereof may be mixed with the iron halide in a dry or powder form, or it may be at least partly present in solution. Further, the Column 6 metal or compound thereof may be added at least partly in a concentrated solution.

Additional catalyst components may also be added to the iron halide/Column 6 metal mixture to provide better incorporation of these components in the iron oxide/Column 6 metal mixture and it may reduce the complexity and cost associated with mixing and mulling the doped regenerator iron oxide with additional catalyst components during later catalyst preparation. Any additional catalyst component that does not impair the conversion of halides to oxides or otherwise negatively impact the heating of the iron halide/Column 6 metal mixture may be added at this stage. For example, a lanthanide that is typically a lanthanide of atomic number in the range of from 57 to 66 (inclusive) may be added to the iron halide/Column 6 metal mixture. The lanthanide is preferably cerium. As additional examples, a metal chloride or titanium or a compound thereof may be added to the iron halide/Column 6 metal mixture. The additional catalyst component is preferably added to the iron halide/Column 6 metal mixture in a form that will convert to the corresponding oxide when heated.

Preparation of the iron halide/Column 6 metal mixture may be carried out by any method known to those skilled in the art. The iron halide may be admixed or otherwise contacted with a Column 6 metal or compound thereof before the mixture is heated. In another embodiment, the iron halide may be admixed with a Column 6 metal or compound thereof during heating.

The mixture comprising an iron halide and a Column 6 metal comprises at least 0.05 millimoles of a Column 6 metal per mole of iron in the mixture, preferably at least 0.1 millimoles, more preferably at least 0.5 millimoles, and most preferably at least 5 millimoles of a Column 6 metal. The mixture may comprise at most 200 millimoles of a Column 6 metal per mole of iron in the mixture, preferably at most 100 millimoles, and more preferably at most 80 millimoles.

Once the iron halide/Column 6 metal mixture has been prepared, the mixture is heated such that at least a portion of the iron halide converts to iron oxide. The iron halide/Column 6 metal mixture may be present in liquid or solid form. The temperature may be sufficient such that at least part of any water and/or other liquids present evaporate. The temperature may be at least about 300° C., or preferably at least about 400° C. The temperature may be from about 300° C. to about 1000° C. or preferably from about 400° C. to about 750° C., but it may also be higher than about 1000° C. The heating may be carried out in an oxidizing atmosphere for example, air, oxygen, or oxygen-enriched air.

The iron halide may be spray roasted as described in U.S. Pat. No. 5,911,967, which is herein incorporated by reference. The iron halide may be spray roasted in the presence of at least one Column 6 metal or compound thereof. Spray roasting comprises spraying a composition through nozzles into a directly heated chamber. The temperatures in the chamber may exceed 1000° C. especially in close proximity to any burner present in the directly heated chamber.

The doped regenerator iron oxide formed by the above-described process may be present predominantly in the form of hematite (Fe₂O₃). The doped regenerator iron oxide may comprise iron oxide in any of its forms, including divalent or trivalent.

In the preferred embodiment, the doped regenerator iron oxide has a residual halide content of at most 1000 ppmw calculated as the weight of halogen relative to the weight of iron oxide calculated as Fe₂O₃, preferably at most 800 ppmw, more preferably at most 500 ppmw, and most preferably at most 250 ppmw. The halide content is preferably at least 1 ppbw, preferably at least 500 ppbw, or more preferably at least 1 ppmw. The halide is typically chloride.

The doped regenerator iron oxide has a surface area that provides for an effective incorporation of catalyst components. In the preferred embodiment, the surface area of the doped regenerator iron oxide is at least 1 m²/g, preferably at least 2.5 m²/g, more preferably at least 3 m²/g, and most preferably at least 3.5 m²/g. As used herein, surface area is understood to refer to the surface area as determined by the BET (Brunauer, Emmett and Teller) method as described in Journal of the American Chemical Society 60 (1938) pp. 309-316.

The catalysts of the present invention may generally be prepared by any method known to those skilled in the art. Typically, the catalyst is prepared by preparing a mixture comprising doped regenerator iron oxide, any other iron oxide(s), at least one Column 1 metal or compound thereof and any additional catalyst component(s), such as any compound referred to below, in a sufficient quantity. Further the mixture may be calcined. Sufficient quantities of catalyst components may be calculated from the composition of the desired catalyst to be prepared. Examples of applicable methods can be found in U.S. Pat. No. 5,668,075; U.S. Pat. No. 5,962,757; U.S. Pat. No. 5,689,023; U.S. Pat. No. 5,171,914; U.S. Pat. No. 5,190,906, U.S. Pat. No. 6,191,065, and EP 1027928, which are herein incorporated by reference.

Iron oxides or iron oxide-providing compounds may be combined with the doped regenerator iron oxide to prepare a catalyst. Examples of other iron oxides include yellow, red, and black iron oxide. Yellow iron oxide is a hydrated iron oxide, frequently depicted as α-FeOOH or Fe₂O₃.H₂O. At least 5 wt %, or preferably at least 10 wt % of the total iron oxide, calculated as Fe₂O₃, may be yellow iron oxide. At most 50 wt % of the total iron oxide may be yellow iron oxide. Additionally, black or red iron oxides may be added to the doped regenerator iron oxide. An example of a red iron oxide can be made by calcination of a yellow iron oxide made by the Penniman method, for example as disclosed in U.S. Pat. No. 1,368,748. Examples of iron oxide-providing compounds include goethite, hematite, magnetite, maghemite, lepidocricite, and mixtures thereof. Additionally, regenerator iron oxide that has not been prepared according to the invention may be combined with the doped regenerator iron oxide.

The quantity of the doped regenerator iron oxide in the catalyst may be at least 50 wt %, or preferably at least 70 wt %, up to 100 wt %, calculated as Fe₂O₃, relative to the total weight of iron oxide, as Fe₂O₃, present in the catalyst.

The Column 1 metal or compound thereof that is added to the catalyst mixture comprises a metal in Column 1 of the Periodic Table that includes lithium, sodium, potassium, rubidium, cesium and francium. One or more of these metals may be used. The Column 1 metal is preferably potassium. The Column 1 metals are generally applied in a total quantity of at least 0.2 mole, preferably at least 0.25 mole, more preferably at least 0.45 mole, and most preferably at least 0.55 mole, per mole iron oxide (Fe₂O₃), and generally in a quantity of at most 5 mole, or preferably at most 1 mole, per mole iron oxide. The Column 1 metal compound or compounds may include hydroxides; bicarbonates; carbonates; carboxylates, for example formates, acetates, oxalates and citrates; nitrates; and oxides.

Additional catalyst components that may be added to the doped regenerator iron oxide include one or more compounds of a Column 2 metal. Compounds of these metals tend to increase the selectivity to the desired alkenylaromatic compound, and to decrease the rate of decline of the catalyst activity. In preferred embodiments, the Column 2 metal may comprise magnesium, calcium or a combination thereof. The Column 2 metals are generally applied in a quantity of at least 0.01 mole, preferably at least 0.02 mole, and more preferably at least 0.03 mole, per mole of iron oxide calculated as Fe₂O₃, and generally in a quantity of at most 1 mole, and preferably at most 0.2 mole, per mole of iron oxide.

Further catalyst components that may be combined with the doped regenerator iron oxide include metals and compounds thereof selected from the Column 3, Column 4, Column 5, Column 6, Column 7, Column 8, Column 9, and Column 10 metals. These components may be added by any method known to those skilled in the art and may include hydroxides; bicarbonates; carbonates; carboxylates, for example formates, acetates, oxalates and citrates; nitrates; and oxides. Catalyst components may be suitable metal oxide precursors that will convert to the corresponding metal oxide during the catalyst manufacturing process.

The method of mixing the doped regenerator iron oxide and other catalyst components may be any method known to those skilled in the art. For example, a paste may be formed comprising the doped regenerator iron oxide, at least one Column 1 metal or compound thereof and any additional catalyst component(s). A mixture may be mulled and/or kneaded or a homogenous or heterogeneous solution of a Column 1 metal or compound thereof may be impregnated on the doped regenerator iron oxide.

In forming the catalyst, a mixture comprising doped regenerator iron oxide, at least one Column 1 metal or compound thereof and any additional catalyst component(s) may be shaped into pellets of any suitable form, for example, tablets, spheres, pills, saddles, trilobes, twisted trilobes, tetralobes, rings, stars, and hollow and solid cylinders. The addition of a suitable quantity of water, for example up to 30 wt %, typically from 2 to 20 wt %, calculated on the weight of the mixture, may facilitate the shaping into pellets. If water is added, it may be at least partly removed prior to calcination. Suitable shaping methods are pelletizing, extrusion, and pressing. Instead of pelletizing, extrusion or pressing, the mixture may be sprayed or spray-dried to form a catalyst. If desired, spray drying may be extended to include calcination.

An additional compound may be combined with the mixture that acts as an aid to the process of shaping and/or extruding the catalyst, for example a saturated or unsaturated fatty acid (such as palmitic acid, stearic acid, or oleic acid) or a salt thereof, a polysaccharide derived acid or a salt thereof, or graphite, starch, or cellulose. Any salt of a fatty acid or polysaccharide derived acid may be applied, for example an ammonium salt or a salt of any metal mentioned hereinbefore. The fatty acid may comprise in its molecular structure from 6 to 30 carbon atoms (inclusive), preferably from 10 to 25 carbon atoms (inclusive). When a fatty acid or polysaccharide derived acid is used, it may combine with a metal salt applied in preparing the catalyst, to form a salt of the fatty acid or polysaccharide derived acid. A suitable quantity of the additional compound is, for example, up to 1 wt %, in particular 0.001 to 0.5 wt %, relative to the weight of the mixture.

In a preferred embodiment, the catalyst is formed as a twisted trilobe. Twisted trilobe catalysts are catalysts with a trilobe shape that are twisted such that when loaded into a catalyst bed, the catalyst pieces will not “lock” together. This shape provides a decreased pressure drop across the bed. Twisted trilobe catalysts are effective in dehydrogenation reactions whether they are formed with regenerator iron oxide, doped regenerator iron oxide, other forms of iron oxide or mixtures thereof. The mixture may be formed into a shape that results in a decreased pressure drop across a catalyst bed. Twisted trilobe catalysts are described in U.S. Pat. No. 4,673,664, which is herein incorporated by reference.

After formation, the catalyst mixture may be calcined. Calcination generally comprises heating the mixture comprising doped regenerator iron oxide, typically in an inert, for example nitrogen or helium or an oxidizing atmosphere, for example an oxygen containing gas, air, oxygen enriched air or an oxygen/inert gas mixture. The calcination temperature is typically at least about 600° C., or preferably at least about 700° C. The calcination temperature will typically be at most about 1200° C., or preferably at most about 1100° C. Typically, the duration of calcination is from 5 minutes to 12 hours, more typically from 10 minutes to 6 hours.

The catalyst formed according to the invention may exhibit a wide range of physical properties. The surface structure of the catalyst, typically in terms of pore volume, median pore diameter and surface area, may be chosen within wide limits. The surface structure of the catalyst may be influenced by the selection of the temperature and time of calcination, and by the application of an extrusion aid.

Suitably, the pore volume of the catalyst is at least 0.01 ml/g, more suitably at least 0.05 ml/g. Suitably, the pore volume of the catalyst is at most 0.5, preferably at most 0.2 ml/g. Suitably, the median pore diameter of the catalyst is at least 500 Å, in particular at least 1000 Å. Suitably, the median pore diameter of the catalyst is at most 10000 Å, in particular at most 7000 Å. In a preferred embodiment, the median pore diameter is in the range of from 2000 to 6000 Å. As used herein, the pore volumes and median applied as well, such as an alkyl substituted naphthalene, anthracene, or pyridine. The alkyl substituent may have any carbon number of two and more, for example, up to 6, inclusive. Suitable alkyl substituents are propyl (—CH₂—CH₂—CH₃), 2-propyl (i.e., 1-methylethyl, —CH(—CH₃)₂), butyl (—CH₂—CH₂—CH₂—CH₃), 2-methyl-propyl (—CH₂—CH(—CH₃)₂), and hexyl (—CH₂—CH₂—CH₂—CH₂—CH₂—CH₃), in particular ethyl (—CH₂—CH₃). Examples of suitable alkylaromatic compounds are butyl-benzene, hexylbenzene, (2-methylpropyl)benzene, (1-methylethyl)benzene (i.e., cumene), 1-ethyl-2-methyl-benzene, 1,4-diethylbenzene, in particular ethylbenzene.

It is advantageous to apply water, which may be in the form of steam, as an additional component of the feed. The presence of water will decrease the rate of deposition of coke on the catalyst during the dehydrogenation process. Typically the molar ratio of water to the alkylaromatic compound in the feed is in the range of from 1 to 50, more typically from 3 to 30, for example 5, 8 or 10.

The dehydrogenation process is typically carried out at a temperature in the range of from 500 to 700° C., more typically from 550 to 650° C., for example 600° C., or 630° C. In one embodiment, the dehydrogenation process is carried out isothermally. In other embodiments, the dehydrogenation process is carried out in an adiabatic manner, in which case the temperatures mentioned are reactor inlet temperatures, and as the dehydrogenation progresses the temperature may decrease typically by up to 150° C., more typically by from 10 to 120° C. The absolute pressure is typically in the range of from 10 to 300 kPa, more typically from 20 to 200 kPa, for example 50 kPa, or 120 kPa.

If desired, one, two, or more reactors, for example three or four, may be applied. The reactors may be operated in series or parallel. They may or may not be operated independently from each other, and each reactor may be operated under the same conditions or under different conditions.

When operating the dehydrogenation process as a gas phase process using a packed bed reactor, the LHSV may preferably be in the range of from 0.01 to 10 h⁻¹, more preferably in the range of from 0.1 to 2 h⁻¹. As used herein, the term “LHSV” means the Liquid Hourly Space Velocity, which is defined as the liquid volumetric flow rate of the hydrocarbon feed, measured at normal conditions (i.e., 0° C. and 1 bar absolute), divided by the volume of the catalyst bed, or by the total volume of the catalyst beds if there are two or more catalyst beds.

The conditions of the dehydrogenation process may be selected such that the conversion of the alkylaromatic compound is in the range of from 20 to 100 mole %, preferably from 30 to 80 mole %, or more preferably from 35 to 75 mole %.

The alkenylaromatic compound may be recovered from the product of the dehydrogenation process by any known means. For example, the dehydrogenation process may include fractional distillation or reactive distillation. If desirable, the dehydrogenation process may include a hydrogenation step in which at least a portion of the product is subjected to hydrogenation by which at least a portion of any alkynylaromatic compound formed during dehydrogenation, is converted into the alkenylaromatic compound. In the dehydrogenation of ethylbenzene to form styrene, the corresponding alkynylaromatic compound is phenylacetylene. The portion of the product subjected to hydrogenation may be a portion of the product that is enriched in the alkynylaromatic compound. Such hydrogenation is known in the art. For example, the methods known from U.S. Pat. No. 5,504,268; U.S. Pat. No. 5,156,816; and U.S. Pat. No. 4,822,936, which are incorporated herein by reference, are readily applicable to the present invention.

Using a catalyst prepared according to the above-described process may decrease the selectivity of the dehydrogenation reaction to the alkynylaromatic compound. Accordingly, it may be possible to reduce the portion of the product that is subjected to hydrogenation. In some cases, the selectivity to the alkynylaromatic compound may be decreased to such an extent that the hydrogenation step may be eliminated.

The alkenylaromatic compound produced by the dehydrogenation process may be used as a monomer in polymerization processes and copolymerization processes. For example, the styrene obtained may be used in the production of polystyrene and styrene/diene rubbers. The improved catalyst performance achieved by this invention with a lower cost catalyst leads to a more attractive process for the production of the alkenylaromatic compound and consequently to a more attractive process which comprises producing the alkenylaromatic compound and the subsequent use of the alkenylaromatic compound in the manufacture of polymers and copolymers which comprise monomer units of the alkenylaromatic compound. For applicable polymerization catalysts, polymerization processes, polymer processing methods and uses of the resulting polymers, reference is made to H. F. Marks, et al. (ed.), “Encyclopedia of Polymer Science and Engineering”, 2^{nd} Edition, new York, Volume 16, pp 1-246, and the references cited therein.

The following examples are presented to illustrate embodiments of the invention, but they should not be construed as limiting the scope of the invention.

### EXAMPLE 1

Doped regenerator iron oxide was made by adding an aqueous solution of ammonium dimolybdate containing 1.45 moles of molybdenum per liter to a waste pickle liquor solution that contained approximately 3.7 moles of iron per liter. Most of the iron was present as FeCl₂. The waste pickle liquor solution contained approximately 150 g/L hydrochloric acid. The waste pickle liquor solution was added to a spray roaster at a rate of about 7.5 m³/h, and the ammonium dimolybdate solution addition rate was adjusted to achieve the desired concentration of molybdenum in the doped regenerator iron oxide. The spray roaster was operated at typical spray roasting conditions known to those skilled in the art. The properties of the doped regenerator iron oxide produced are shown in Table 1.

### EXAMPLE 2

Regenerator iron oxide was made by the method of Example 1, except that ammonium dimolybdate was not added to the waste pickle liquor solution. The properties of the regenerator iron oxide produced are shown in Table 1.

### EXAMPLE 3

A catalyst was prepared using the regenerator iron oxide of Example 2. The following ingredients were combined: 900 g regenerator iron oxide and 100 g yellow iron oxide with sufficient potassium carbonate, cerium carbonate, molybdenum trioxide, and calcium carbonate to give the composition shown in Table 2. Water (about 10 wt %, relative to the weight of the dry mixture) was added to form a paste, and the paste was extruded to form 3 mm diameter cylinders cut into 6 mm lengths. The pellets were dried in air at 170° C. for 15 minutes and subsequently calcined in air at 825° C. for 1 hour. pore diameters are as measured by mercury intrusion according to ASTM D4282-92, to an absolute pressure of 6000 psia (4.2×10⁷ Pa) using a Micromeretics Autopore 9420 model; (130° contact angle, mercury with a surface tension of 0.473 N/m). As used herein, median pore diameter is defined as the pore diameter at which 50% of the mercury intrusion volume is reached.

The surface area of the catalyst is preferably in the range of from 0.01 to 20 m²/g, more preferably from 0.1 to 10 m²/g.

The crush strength of the catalyst is suitably at least 10 N/mm, and more suitably it is in the range of from 20 to 100 N/mm, for example about 55 or 60 N/mm.

In another aspect, the present invention provides a process for the dehydrogenation of an alkylaromatic compound by contacting an alkylaromatic compound and steam with a doped regenerator iron oxide based catalyst made according to the invention to produce the corresponding alkenylaromatic compound. The dehydrogenation process is frequently a gas phase process, wherein a gaseous feed comprising the reactants is contacted with the solid catalyst. The catalyst may be present in the form of a fluidized bed of catalyst particles or in the form of a packed bed. The process may be carried out as a batch process or as a continuous process. Hydrogen may be a further product of the dehydrogenation process, and the dehydrogenation in question may be a non-oxidative dehydrogenation. Examples of applicable methods for carrying out the dehydrogenation process can be found in U.S. Pat. No. 5,689,023; U.S. Pat. No. 5,171,914; U.S. Pat. No. 5,190,906; U.S. Pat. No. 6,191,065, and EP 1027928, which are herein incorporated by reference.

The alkylaromatic compound is typically an alkyl substituted benzene, although other aromatic compounds may be The composition of the catalyst after calcination is shown in Table 2 as moles per mole of iron oxide, calculated as Fe₂O₃.

A 100 cm³ sample of the catalyst was used for the preparation of styrene from ethylbenzene under isothermal testing conditions in a reactor designed for continuous operation. The conditions were as follows: absolute pressure 76 kPa, steam to ethylbenzene molar ratio 10, and LHSV 0.65 h⁻¹. In this test, the initial temperature was held at 600° C. The temperature was later adjusted such that a 70 mole % conversion of ethylbenzene was achieved (T70). The selectivity (S70) to styrene at the selected temperature and the phenylacetylene (PA) content of the product were measured. The data is presented in Table 2.

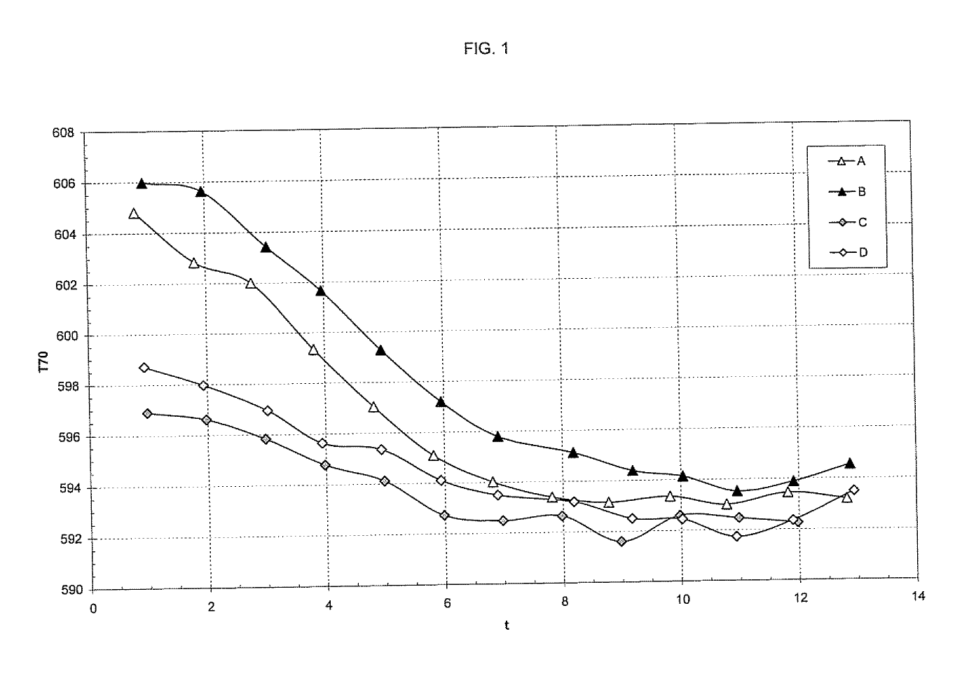

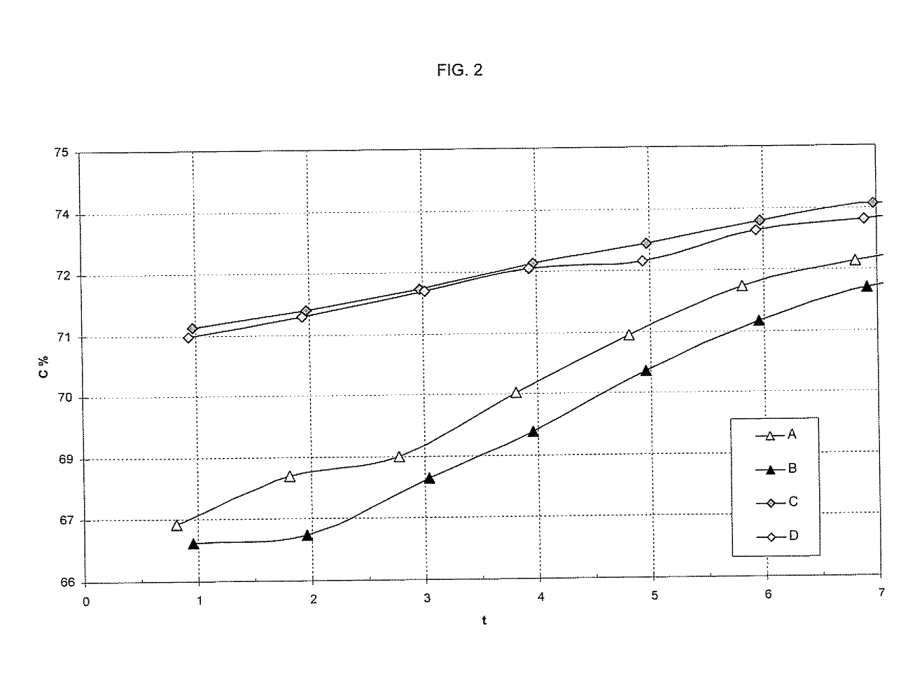

The performance and startup behavior of this catalyst is shown in FIGS. 1 and 2 at the test conditions described above. The catalyst was tested in duplicate (A, B). FIG. 1 shows the calculated catalyst activity at 70% conversion of the catalyst, and FIG. 2 shows the actual conversion of the catalyst.

### EXAMPLE 4

A catalyst was prepared and tested using doped regenerator iron oxide as described in Example 1. The catalyst was prepared and tested using the methods and materials of Example 3 except that additional molybdenum trioxide was not added during catalyst preparation. The initial temperature was held at 600° C., and the temperature was later adjusted such that a 70% mole % conversion of ethylbenzene was achieved. The catalyst composition, after calcining, and the performance of the catalyst in the preparation of styrene are presented in Table 2.

The performance and startup behavior of this catalyst, which was also tested in duplicate (C, D) is also shown in FIGS. 1 and 2. The isothermal testing conditions were the same as those described in Example 3.

### EXAMPLE 5

A catalyst was prepared and tested using the doped regenerator iron oxide of Example 1 according to Example 4 and additional potassium was added. The catalyst testing conditions were the same as those described in Example 3. The composition and performance data are presented in Table 2.

### EXAMPLE 6

A catalyst was prepared and tested using the regenerator iron oxide of Example 2. The catalyst was prepared with an additional amount of cerium carbonate. The catalyst was tested as described in Example 3, except that the initial temperature was 590° C. and was later adjusted to achieve 70% conversion. The composition and performance data are presented in Table 2.

### EXAMPLE 7

A catalyst was prepared and tested using the doped regenerator iron oxide of Example 1. The catalyst was prepared with an additional amount of cerium carbonate. The catalyst was tested as described in Example 6. The initial temperature was 590° C. and was later adjusted to achieve 70% conversion. The composition and performance data are presented in Table 2.

TABLE 1

| | Example 1 | Example 2 |
|---|---|---|
| Cl— (wt %) | 0.039 | 0.063 |
| Mo (wt %) | 1.140 | 0.004 |
| BET Surface Area (m²/g) | 4.3 | 3.0 |

TABLE 2

| | Composition | Performance | | |
|---|---|---|---|---|
| Example | (mole/mole iron oxide) | T70 | S70 | Phenylacetylene |

| No. | K | Mo | Ca | Ce | (° C.) | (%) | (ppm) |
|---|---|---|---|---|---|---|---|
| 3 | 0.516 | 0.022 | 0.027 | 0.066 | 594 | 95.4 | 146 |
| 4 | 0.516 | 0.019 | 0.027 | 0.066 | 592 | 94.7 | 124 |
| 5 | 0.615 | 0.019 | 0.027 | 0.066 | 593 | 95.3 | 138 |
| 6 | 0.615 | 0.018 | 0.025 | 0.120 | 592 | 94.6 | 127 |
| 7 | 0.615 | 0.019 | 0.025 | 0.120 | 589 | 94.3 | 119 |

As can be seen from the foregoing examples, the catalyst made using the doped regenerator iron oxide of Example 1 shown by Examples 4 and 7 was more active than a catalyst with a similar composition but made using the regenerator iron oxide of Example 2 shown by Examples 3 and 6. Additionally, the catalysts of Examples 4 and 5 exhibited a lower phenylacetylene production than the catalyst of Example 3. The catalyst of Example 7 also exhibited a lower phenylacetylene production than the catalyst of Example 6.

The catalyst of Example 5 shows that the selectivity of a catalyst made using doped regenerator iron oxide as shown by Example 4 can be increased with a corresponding loss in activity, but still maintaining a higher activity than the catalyst made with regenerator iron oxide as shown by Example 3.

As can be seen from FIG. 1, the catalysts C and D made with doped regenerator iron oxide exhibit a higher initial activity than the catalysts A and B made with regenerator iron oxide. This is reinforced by FIG. 2 that shows that catalysts C and D exhibit a higher initial conversion than catalysts A and B.

What is claimed is:

1. A process for preparing a catalyst which process comprises preparing a mixture comprising iron oxide and at least one Column 1 metal or compound thereof, wherein the iron oxide is obtained by heating a mixture comprising an iron halide and at least 0.05 millimoles of a Column 6 metal per mole of iron.

2. A process as claimed in claim 1 wherein the mixture comprises from about 0.5 to about 100 millimoles of a Column 6 metal per mole of iron.

3. A process as claimed in claim 1 wherein the mixture comprises from about 2.5 to about 30 millimoles of a Column 6 metal per mole of iron

4. A process as claimed in claim 1 wherein the Column 6 metal is present as a compound of a Column 6 metal.

5. A process as claimed in claim 4 wherein the Column 6 metal compound is selected from the group consisting of chlorides, hydroxides, oxides, and carbonates of Column 6 metals.

6. A process as claimed in claim 4 wherein the Column 6 metal compound comprises an ammonium salt of an acid derived from the Column 6 metal.

7. A process as claimed in claim 1 wherein the Column 6 metal is molybdenum.

8. A process as claimed in claim 1 wherein the Column 1 metal or compound thereof comprises potassium.

9. A process as claimed in claim 1 wherein the process further comprises adding a Column 2 metal or compound thereof to the mixture of iron oxide and Column 1 metal.

10. A process as claimed in claim 1 wherein the process further comprises adding cerium to the mixture of iron oxide and Column 1 metal.

11. A process as claimed in claim 1 wherein the iron halide comprises an acidic solution of an iron chloride.

12. A process as claimed in claim 1 wherein the temperature of the heating is in the range of from about 300° C. to about 1000° C.

13. A process as claimed in claim 1 wherein the temperature of the heating is in the range of from about 400° C. to about 750° C.

14. A process as claimed in claim 1 wherein the heating comprises spray roasting.

15. A process as claimed in claim 1 further comprising calcining the mixture at a temperature of from about 600° C. to about 1200° C.

16. A process as claimed in claim 1 comprising calcining the mixture at a temperature of from about 700° C. to about 1100° C.

17. A catalyst prepared by the process of claim 1.

18. A catalyst as claimed in claim 17 wherein the halide content of the iron oxide is at most about 1000 ppmw.

19. A catalyst as claimed in claim 17 wherein the halide content of the iron oxide is at most about 500 ppmw.

20. A catalyst as claimed in claim 17 wherein the halide content of the iron oxide is at most about 100 ppmw.

21. A composition comprising iron oxide formed by heating an iron chloride in the presence of at least one Column 6 metal per mole of iron, and at least one Column 1 metal or compound thereof wherein the iron oxide has a chloride content of at most 500 ppmw and a BET surface area of at least 2.5 m²/g.

22. A composition as claimed in claim 21 wherein the chloride content is at most 250 ppmw.

23. A composition as claimed in claim 21 wherein the BET surface area is at least 3.5 m²/g

24. A process for preparing a catalyst comprising calcining the composition as claimed in claim 21.

25. A catalyst comprising the composition claim 21 wherein the composition is calcined at a temperature of from about 600° C. to about 1200° C.

26. A process for the dehydrogenation of an alkylaromatic compound which process comprises contacting a feed comprising the alkylaromatic compound with the catalyst of claim 17.

27. A process as claimed in claim 26 wherein the alkylaromatic compound comprises ethylbenzene.

28. A method of using an alkenylaromatic compound for making polymers or copolymers, comprising polymerizing the alkenylaromatic compound to form a polymer or copolymer comprising monomer units derived from the alkenylaromatic compound, wherein the alkenylaromatic compound has been prepared in a process for the dehydrogenation of an alkylaromatic compound as claimed in claim 26.

29. A catalyst comprising doped regenerator iron oxide and potassium or a compound thereof wherein the doped regenerator iron oxide is obtained by heating an iron chloride compound in the presence of at least 5 millimoles of molybdenum per mole of iron.

30. A process for preparing a catalyst which process comprises preparing a mixture comprising iron oxide and at least one Column 1 metal or compound thereof wherein the iron oxide is obtained by adding molybdenum or a compound thereof to an iron chloride mixture and heating the mixture.
